(19) United States
(12) Patent Application Publication
(10) Pub. No.: US 2003/0227820 A1
(43) Pub. Date: Dec. 11, 2003

(54) Apparatus for mixing, combining or dissolving fluids or fluidized components in each other

(76) Inventor: Kenneth Gaylord Parrent, Fairfield, MT (US)

Correspondence Address: Kenneth G. Parrent, 148 E. Division, Fairfield, Mt., Fairfield, MT, 59436, US

(21) Appl. No.: 10/162,253

(22) Filed: Jun. 5, 2002

(51) Int. Cl. B01F 13/00

(52) U.S. Cl. 366/162.4

(57) ABSTRACT

Opposing high-velocity (primary) streams of fluid are introduced into a passage through primary-fluid nozzles situated at opposite ends of said passage.

Also, one or more (secondary) streams of fluids, or fluidized mixtures of any type are fed into said passage through ports located downstream from the primary-fluid nozzles. The primary fluid streams impinge upon the secondary streams thereby accelerating each secondary stream along its respective passage away from the primary-fluid nozzles toward a point of collision of the two accelerated streams. The collision of the two streams creates an efficient condition for utilizing the Kinetic energy in the incoming streams for mixing or commingling the constituents of the incoming opposing streams.

### FIELD OF THE INVENTION

The present invention relates to the field of mixing fluids and/or fluidized solids. More specifically, the present invention is an apparatus for mixing fluids or fluidized components in a controlled, high-energy environment resulting from the collision of two high-velocity streams approaching the zone of collision from opposing directions. The prior art teaches that impinging moving particles on a fixed surface enhances the effectiveness of solvents used in process.

In contrast, the principal of the present invention employs the more efficient and more effective practice of directing two high-velocity streams of fluids or fluidized substances toward each other and at their common zone of intersection gaining an amplified benefit from the expenditure of the Kinetic energy of the two colliding streams impinging upon each other.

### BACKGROUND OF THE INVENTION

Mixing two or more components in fluid or fluidized form is a process that has been in use for a great many years. Prior art methods have been developed for creating a homogenous mixture of two or more ingredients by various types of rotating or jet-type devises employed to commingle two or more constituents while all are held in a confining vessel. The prior art teaches that the effectiveness Of the mixing operation can be enhanced by increasing the shear-rate within the mixture by means of rotating devices such as propellers, slotted cages, helixes, paddles, tumblers, drums and/or augers. The prior art also teaches that increased temperature will accelerate and/or improve the process of combining constituents both mechanically and chemically.

### DESCRIPTIVE SUMMARY OF THE INVENTION

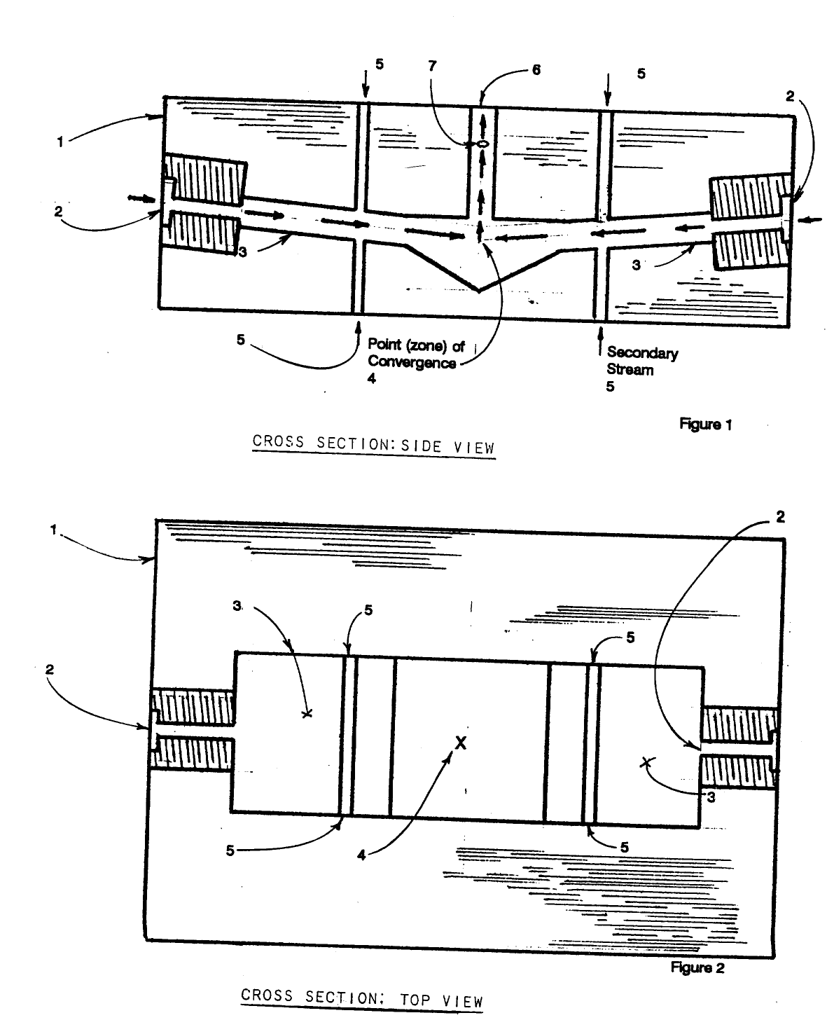

The present invention comprises an apparatus for mixing, blending or combining two or more fluids or fluidized substances by means of accelerating two streams of components to a zone of collision thereby increasing the Kinetic energy available to the colliding components by a factor approximating 400% percent as the angle between the colliding steams approaches 180° (degrees). (FIG. 1).

A primary stream of high-velocity fluid is introduced through a primary nozzle at each and opposing ends of a passage. A secondary fluid or fluidized component is fed into the passage through elongated ports or holes extending across the passage down stream from each of the primary nozzles introducing the primary-fluid streams. Each primary-fluid stream impinges upon the secondary stream and accelerates the components of the secondary stream along the passage away from the primary nozzle to a zone of intersection of the two passages where the two accelerated streams collide with each other resulting in the conversion of the Kinetic energy in each stream to “work” and to heat as the two high-velocity streams impinge upon each other. The work along with the attendant heat generated by the work results in efficient physical mixing and/or chemical combination of the constituents of the converging streams. The mixture subsequently exits the device in a continuous process.

The principal objectives of the present invention are to provide an apparatus:

(1) In which mixing efficiency will be improved,

(2) To accelerate the rate of a chemical combination or the rate of shear in a mixing process,

(3) For continuous mixing versus “batch” mixing,

(4) That will facilitate the efficient introduction of high levels of energy into the mixing process, or into a chemical-reaction,

(5) Which will increase the efficient utilization of the energy introduced therein,

(6) Of small size that will satisfy the same process step traditionally requiring a much larger device,

(7) That is versatile and adaptable to numerous kinds of feed,

(8) That will reduce mixing time, and/or chemical-reaction time requirements,

(9) That requires very little maintenance,

(10) That will efficiently consume a very large percentage of the available Kinetic energy to efficiently process discrete quantifies of substances,

(11) Which will amplify the benefits to be obtained from the available Kinetic energy within the introduced substances.

### DESCRIPTION OF THE DRAWINGS

The present invention may be best understood by referring to the accompanying drawings in which FIG. 1 is a cross-sectional side view of the present invention and FIG. 2 is a cross-sectional top view of the present invention taken along the center plane of the two intersecting passages.

### DETAILED PHYSICAL DESCRIPTION TO THE INVENTION

Referring to FIG. 1, the apparatus is shown generally as 1. In operation the primary fluid is pumped at high pressure, (no upper limit) through nozzles 2 into primary passages 3 extending along the axes of nozzles 2 toward a common point of convergence 4: The external housing of the apparatus shown in FIG. 1 can be composed of material suitable for any chosen process, i.e. steel, plastic, ceramic, etc. nozzles 2 are affixed to housing 1 in a position to permit nozzles 2 to discharge fluid into primary passages 3. FIGS. 1 and 2 show that primary passages 3 are relatively wider than they are high, however, the dimensions of passages 3 may be varied depending upon process requirements.

A secondary stream of material whether it be dry, fluid or fluidized is introduced into passages 3 through inlet ports 5 extending from the outside surfaces of the apparatus to intersect passages 3. As the secondary stream enters passage 3 through ports 5, the secondary steam will be contacted by the incoming primary stream of fluid from nozzles 2 and thereby accelerated along passages 3 away from nozzles 2. The combined stream of the materials in the primary and secondary streams is then carried along passages 3 away from nozzles 2 to a zone of convergence 4 where the two streams of mixture collide with each other to mix and to expend their energy of motion on each other (their Kinetic energy).

The mixture is removed from the zone of collision 4 through passage 6 with assistance from eductor nozzle 7 through which fluid or gas may be discharged into passage 6 to assist in the removal of the mixture from passage 6.

To explain further: Prior art methods of inducing shear between two or more streams of fluids and/or fluidized components requires that the streams to be combined impinge upon a fixed or stationary surface to induce shear and turbulence to achieve the desired degree of commingling of the constituents in the stream. The theoretical explanation of the mixing process is as follows (from classic physics):

A moving stream possesses “energy of motion” which is due to the constituents comprising the stream being in motion. The greater the velocity of a specific stream, the greater will be the “energy of motion” possessed by that specific stream. This “energy of motion” is called Kinetic energy and is defined in the literature by the following equation:

EK=½mV² (Equation 1)

Where:

EK=Kinetic energy in foot pounds.

m=mass of a specific material in pounds.

V=velocity of the mass in feet per second.

Which states that for a mass of constant weight any increase in its velocity will result in an increase in EK the Kinetic energy possessed by the mass. Classic Physics further states that if a mass contains energy—such as Kinetic energy—the mass is able to do work, therefore, it follows that an increase in Kinetic energy possessed by a given mass results in an increase in the ability of the mass to do work (in this case the work is commingling, blending of mixing substances compounds, slurries, fluids and materials of kinds in fluidized form.)

Prior art methods of impinging a moving stream of particles on a fixed or stationary surface results in a large number of the moving particles in the stream coming to a complete stop upon contact with the fixed surface. Upon coming to a complete stop the velocity V of the particles has decreased to zero, which, when inserted into Equation (1) results in EK, the Kinetic energy of the particles becoming zero. Thus, the Kinetic energy originally possessed by the moving particles has been expended against the fixed or stationary surface which is neither mixed into nor chemically combined in the process. Particles that impinge upon the fixed surface at angles other than 90° will not come to a complete stop, but will be deflected at a reduced velocity and will thus have lost a portion of their Kinetic energy. The loss of Kinetic energy in the particles is a loss of ability of the particles to do work, or to further explain—the particle have a reduced ability to contribute energy to the mixing or chemical-combination process.

Now turning to this invention where two streams of particles approach a zone of intersection from opposing directions:

Each stream has a velocity V equal to the velocity of the other stream. The velocity of any particle in one stream related to the velocity of any particle in the other stream is known as “The relative velocity” of any particle in one stream with respect to any particle in the other stream. This means that a particle approaching the zone of intersection from the left at velocity V while simultaneously another particle is approaching the zone of intersection from the right at velocity V the two particles are approaching each other at a relative velocity equal to V+V=2V.

Now returning to Equation 1 to illustrate the significance of increasing the relative velocity by a factor of two the following example is given:

EK=½mV² (1)

Given

m=4 dimensionless units (the mass) and

V=4 dimensionless units (the steam's velocity).

Thus, by substitution into equation (1)

$$\begin{matrix}EK = 1 / 2 \times 4 \times {( 4 )}^{2} \\ = 1 / 2 \times 4 \times 16 = 32 dimensionless units .\end{matrix}$$

Now taking the situation extant in this invention where the relative velocity of the two streams approaching each other equals 2V or 8 dimensionless units we have by Equation (1):

EK=½×4×(8)²=½×4×64=128 dimensionless units or a 400% (percent) increase in available Kinetic energy possessed by the moving particles in the two streams approaching each other. Since in this invention the two streams approach a zone of collision with each other instead of a stationary, fixed surface the entirety of the Kinetic energy contained in the moving particles is available to do work upon the constituents within the two streams, instead of being expended by collision with a stationary or fixed surface. To clarify further: A stream of particles impinging upon a fixed or stationary surface contains “X” amount of Kinetic energy to be expended against said fixed or stationary surface, however, by Equation (1) two such streams colliding with each other in a common plane contain 4× amount of Kinetic energy to be expended by virtue of their relative velocity. Further clarification and proof is demonstrated below in the mathematical presentation.

### MATHEMATICAL PRESENTATION

The following mathematical presentation demonstrates the manner in which two streams containing Kinetic energy of equal quantities converging upon each other at an angle approaching 180° (degrees) from each other and in a common plane will reach a maximum value when their angle of convergence of the two streams equals 180° (degrees) one from the other.

At the angle of maximum convergence (180° (degrees) the full quantity of Kinetic energy in each stream impinges upon the other stream.

Each stream is approaching the other stream at velocity V, that is to say, stream A is approaching the common zone of convergence at velocity V and stream B is approaching the common zone of convergence at velocity V. Under these conditions every particle in each stream is approaching every particle in the other stream at a combined velocity of 2V which is the relative velocity of every particle in either stream with respect to every particle in the other stream.

All quantities shown are dimensionless

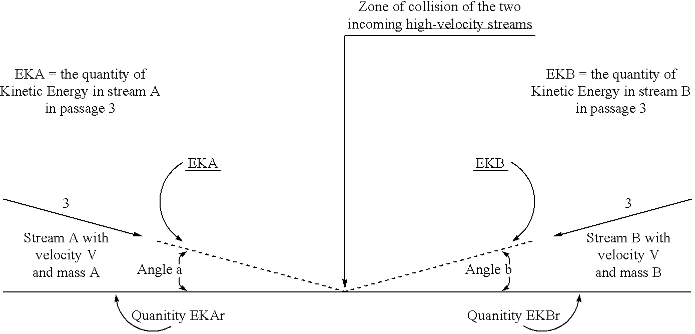

GIVEN: Mass A=Mass B

The quantity of Kinetic energy EKA=the quantity of Kinetic energy EKB

Angle a=Angle b varying from 0° to 90°

Therefore Cosine a=Cosine b and from the law of Cosines

Cosine a=EKar/EKA

and Cosine b=EKbr/EKB

By rearranging terms:

EKAr=(Cosine a) (EKA)

and

EKBr=(Cosine b) (EKB).

Since

Cosine Angle a=Cosine Angle b

and

Quantity EKA=Quantity EKB

then

Quantity EKAr=Quantity EKBr

As angles a and b vary from 0° (zero degrees) to 90° (ninety degrees) their respective cosines very from 1.000 where angles a and b equal 0° (zero degrees) to zero where angles a and b equal 90° (ninety degrees) (from the table of natural sines and cosines found in “Mathematical Tables” from Handbook of Chemistry and Physics published by Chemical Rubber Publishing Company, Cleveland, Ohio.)

Again referring to Equation (1) the Kinetic energy in any particle in either stream is calculated upon the basis of its relative velocity with respect to any particle it will meet at the point of convergence and since the relative velocity of every particle is 2V Equation (1):

EK=½×m×V²

and when V=1 & m=4

$$\begin{matrix}EK = 1 / 2 \times 4 \times {1}^{2} \\ = 2.\end{matrix}$$

Whereas any particle in either stream traveling at relative velocity V=2 possesses Kinetic energy of the following quantity calculated by Equation (1):

$$\begin{matrix}EK = 1 / 2 \times 4 \times {2}^{2} \\ = 8.\end{matrix}$$

Thus the proof is complete that two opposing streams of equal mass approaching each other in a common plane will contain a quantity of available Kinetic energy equal to 400% (percent) of either stream approaching a stationary surface whose velocity equals zero.

I claim:

1. An apparatus for mixing two or more fluids or fluidized components, comprising:
(a) Two or more nozzles through which high-velocity streams of fluid are introduced;
(b) A passage extending axially from each nozzle to a zone of intersection of one passage with the other;
(c) Additional inlet ports to allow various materials to be introduced into said passages (b) above downstream of nozzles (a) above;
(d) A zone of intersection of the two passages in (b) above midway and equidistant from the two nozzles in (a) above;
(e) A zone of collision of the incoming high-velocity streams of materials that results in the Kinetic energy possessed by each incoming stream being expended on the opposing incoming stream;
(f) The creation of a condition at the zone of collision of the two opposing, incoming steams whereby the Kinetic energy available to do work is, in fact, approximately equal to a maximum of 400% (percent) of the Kinetic energy available in one similar stream of material doing work by impinging upon a fixed surface or upon a particle at rest and in the path of the incoming high velocity stream or upon a particle traveling in a direction oriented 90° (degrees) from the direction of travel of the incoming high-velocity stream and in the path of the incoming high-velocity stream.

2. The passage (b) of claim 1 widens laterally away from each nozzle to allow a fan-shaped spray of high-velocity fluid to emanate from each nozzle.

3. The apparatus of claim 2 wherein the inlet ports are one or more slots or holes extending across the width of the passage.

4. The apparatus of claim 3 further comprising adjustable inlet ports to permit adjusting the width and position of the inlet port or slot.

5. The apparatus of claim 1 wherein there exists a chamber at the intersection of the two passages in 1 (b) above to function as a zone of collision.

6. An apparatus for mixing two or more components comprising:
(a) Two opposing nozzles to emit high-velocity streams of fluid which amplifies the magnitude of usable Kinetic energy contained within the streams.
(b) Two passages extending axially from said nozzles.
(c) Inlet ports comprising a slot or series of slots or holes arranged linearly extending across the width of the passage through which additional components or materials can be introduced into the passages to be impinged and accelerated ed toward the zone of intersection of passages 6(b) above.
(d) A mixing chamber at a position midway between the opposing nozzles 6 (a) above.
(e) A discharge passage through which the materials in the mixing chamber can be discharged.
(f) A port in the discharge passage of (e) through which fluid or gas may be introduced to assist the discharge of the material in (e).
